(19) United States
(12) Patent Application Publication
(10) Pub. No.: US 2026/0124718 A1
(43) Pub. Date: May 7, 2026

(54) HOLDING DEVICE FOR HOLDING PIPES IN A CHAIN VISE

(71) Applicant: Scott Bauman, Douglas, WY (US)

(72) Inventor: Scott Bauman, Douglas, WY (US)

(21) Appl. No.: 18/940,567

(22) Filed: Nov. 7, 2024

(51) Int. Cl. B25B 1/20

(52) U.S. Cl. CPC B25B 1/205

(57) ABSTRACT

A holding device for holding pipes in a chain vise includes an angled bracket, a plurality of teeth, and a pair of chain guide slots. The angled bracket has a top surface, a bottom surface, and lateral surfaces. The angled bracket includes a first bracket portion, a second bracket portion, and a central bracket portion. The bottom surface is angled less than 160 degrees. The teeth are on the bottom surface and designed to engage and grip an upper portion of a pipe positioned on a jaw of a chain vise. The chain guide slots are positioned in the first and second bracket portions, and thereby divide the portions into a pair of legs extending away from the central bracket portion. The chain guide slots are designed to receive and guide between the pair of legs portions of a chain of the chain vise placed on the top surface.

### (b) CROSS-REFERENCE TO RELATED APPLICATIONS

Not Applicable

### (c) STATEMENT REGARDING FEDERALLY SPONSORED RESEARCH OR DEVELOPMENT

Not Applicable

### (d) THE NAMES OF THE PARTIES TO A JOINT RESEARCH AGREEMENT

Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### (f) Statement Regarding Prior Disclosures by the Inventor or JOINT INVENTOR

Not Applicable

### (g) BACKGROUND OF THE INVENTION

### (1) Field of the Invention

The disclosure relates to chain vises and more particularly pertains to a new holding device for improving the gripping ability of chain vises. As is well known, chain vises are tools that have a toothed jaw mounted on a support, which is affixed to a table or similar. A pipe is placed on the jaw, and then a chain is wrapped around the pipe and tightened and locked in place. The chain and the jaw work together to hold the pipe and prevent rotation. However, many chain vises still suffer from slippage of the pipe, especially as the chain and jaw become worn over time. The new holding device is placed on the upper surface of the pipe seated in the jaw of the chain vise, between the chain and the pipe, to provide two separate gripping forces on the top and bottom of the pipe to prevent the pipe from sliding or rotating when being cut or having screw threads cut therein.

### (2) Description of Related Art Including Information Disclosed Under 37 CFR 1.97 and 1.98

The prior art relates to chain vises. The prior art, as best understood, does not disclose a holding device that includes an angled bracket, a plurality of teeth, and a pair of chain guide slots. The teeth are positioned on the bottom surface of the angled bracket and are designed to engage and grip an upper portion of a pipe positioned on a jaw of a chain vise, and the chain guide slots guide a chain of the chain vise placed over the top surface of the angled bracket.

### (h) BRIEF SUMMARY OF THE INVENTION

An embodiment of the disclosure meets the needs presented above in a holding device generally comprising an angled bracket, a plurality of teeth, and a pair of chain guide slots. The angled bracket has a top surface, a bottom surface, and lateral surfaces connecting the top surface and the bottom surface. The angled bracket includes a first bracket portion, a second bracket portion, and a central bracket portion connecting the first bracket portion and the second bracket portion. A first section of the bottom surface positioned on the first bracket portion and a second section of the bottom surface positioned on the second bracket portion form an angle less than 160 degrees. The teeth are positioned on the bottom surface. The teeth are designed to engage and grip an upper portion of a pipe positioned on a jaw of a chain vise. Each of the chain guide slots is positioned in a respective one of the first bracket portion and the second bracket portion. Each of the chain guide slots is positioned to divide a respective one of the first bracket portion and the second bracket portion into a pair of legs extending away from the central bracket portion. Each of the chain guide slots is designed to receive and guide between the pair of legs portions of a chain of the chain vise placed on the top surface of the angled bracket.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a holding device according to an embodiment of the disclosure.

FIG. 2 is a top view of an embodiment of the disclosure.

FIG. 3 is a side view of an embodiment of the disclosure.

FIG. 4 is a bottom view of an embodiment of the disclosure.

FIG. 5 is a front view of an embodiment of the disclosure.

FIG. 6 is a perspective view of an embodiment of the disclosure in use.

FIG. 7 is a perspective view of an embodiment of the disclosure in use.

FIG. 8 is a perspective view of an embodiment of the disclosure in use.

### (j) DETAILED DESCRIPTION OF THE INVENTION

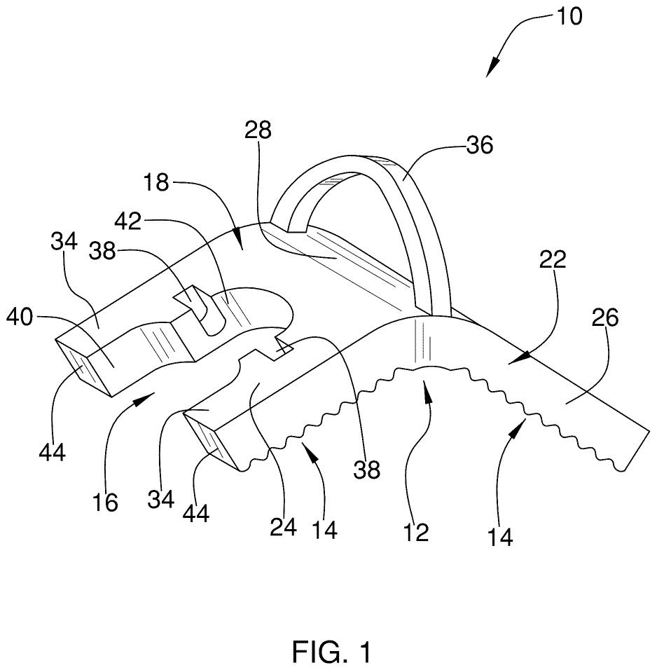

With reference now to the drawings, and in particular to FIGS. 1 through 8 thereof, a new holding device embodying the principles and concepts of an embodiment of the disclosure and generally designated by the reference numeral 10 will be described.

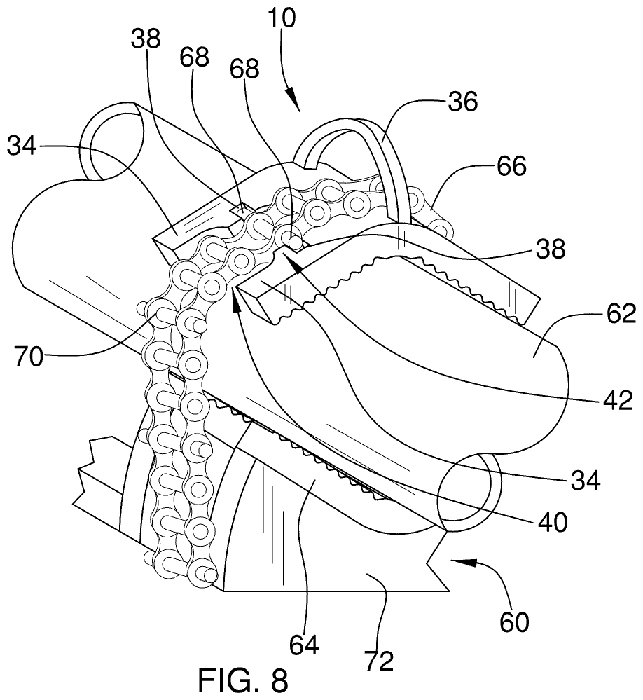

As best illustrated in FIGS. 1 through 8, the holding device 10 for holding pipes in a chain vise 60 generally comprises an angled bracket 12, a plurality of teeth 14, and a pair of chain guide slots 16. In the exemplary embodiment shown in FIGS. 1 through 5, the angled bracket 12 has a top surface 18, a bottom surface 20, and lateral surfaces 22 connecting the top surface 18 and the bottom surface 20. The angled bracket 12 includes a first bracket portion 24, a second bracket portion 26, and a central bracket portion 28 connecting the first bracket portion 24 and the second bracket portion 26. A first section 30 of the bottom surface 20 positioned on the first bracket portion 24 and a second section 32 of the bottom surface 20 positioned on the second bracket portion 26 form an angle less than 160 degrees. The teeth 14 are positioned on the bottom surface 20. The teeth 14 are designed to engage and grip an upper portion of a pipe 62 positioned on a jaw 64 of the chain vise 60, as shown in FIG. 8. Each of the chain guide slots 16 is positioned in a respective one of the first bracket portion 24 and the second bracket portion 26. Each of the chain guide slots 16 is positioned to divide a respective one of the first bracket portion 24 and the second bracket portion 26 into a pair of legs 34 extending away from the central bracket portion 28. Each of the chain guide slots 16 is designed to receive and guide between the pair of legs 34 portions of a chain 66 of the chain vise 60 placed on the top surface 18 of the angled bracket 12, as shown in FIG. 8.

In the exemplary embodiment, the holding device 10 also includes an arch 36. The arch 36 projects from the top surface 18 of the angled bracket 12. The arch 36 extends across the central bracket portion 28 toward each of the lateral surfaces 22. The arch 36 is designed to receive the chain 66 of the chain vise 60 inserted between the arch 36 and the top surface 18 of the angled bracket 12, as shown in FIG. 8. While the arch 36 is curved in the exemplary embodiment, other shapes, such as a square or a triangle or a trapezoid, are within the scope of the disclosure.

The holding device 10 further includes a pair of pin grooves 38. Each of the pin grooves 38 is positioned on opposing sides of the chain guide slot 16 in the first bracket portion 24 and extends toward a respective one of the lateral surfaces 22. The pin grooves 38 are designed to receive any one of a plurality of link pins 68 in the chain 66 of the chain vise 60 to further secure the chain 66 of the chain vise 60 in engagement with the angled bracket 12, as shown in FIG. 8.

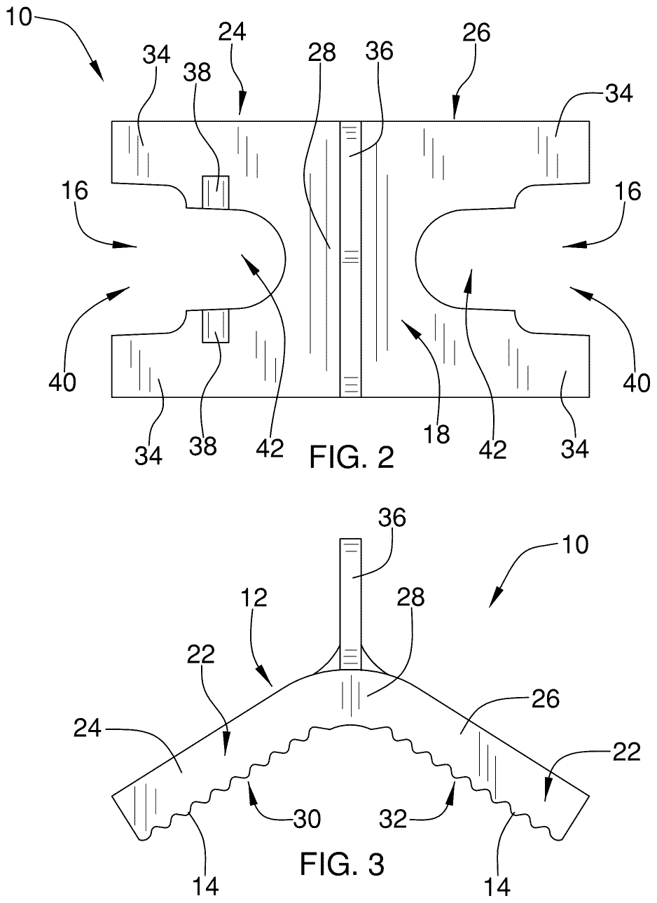

As best seen in FIG. 2, each of the chain guide slots 16 includes a wider slot portion 40 and a narrower slot portion 42. The wider slot portion 40 extends from end faces 44 of the pair of legs 34 of a respective one of the first bracket portion 24 and the second bracket portion 26 toward the central bracket portion 28. The narrower slot portion 42 extends from the wider slot portion 40 toward the central bracket portion 28. The pin grooves 38 are positioned to extend from the narrower slot portion 42 of the chain guide slot 16 of the first bracket portion 24. In the exemplary embodiment, a width of the wider slot portion 40 is the same as a distance between respective ends of the pin grooves 38 to permit insertion of a link 70 of the chain 66 of the chain vise 60 and the link pins 68 projecting from the link 70 into the wider slot portion 40 between the pair of legs 34.

The lateral surfaces 22 are parallel to one another, though in another possible embodiment they could be contoured or tapered or otherwise arranged to not be parallel.

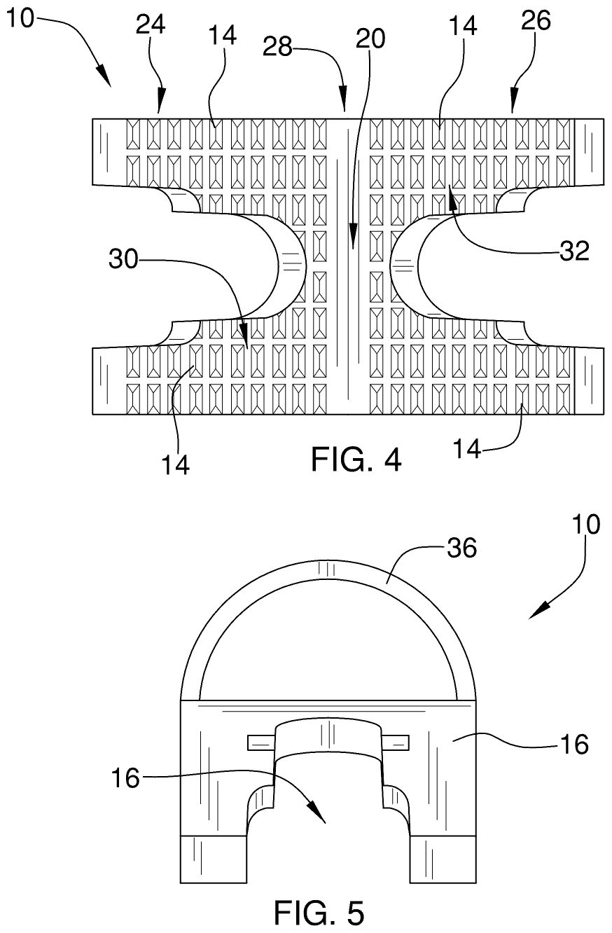

In the exemplary embodiment in FIG. 4, the bottom surface 20 of the angled bracket 12 is smooth and curved at the central bracket portion 28. The teeth 14 are positioned across the entirety of the bottom surface 20 at each of the first bracket portion 24 and the second bracket portion 26. However, other configurations of the teeth 14 are within the scope of the disclosure as is well known in the gripping arts.

In one possible embodiment, the first section 30 and the second section 32 of the bottom surface 20 are positioned at an angle to one another of less than 140 degrees. In another possible embodiment, the first section 30 and the second section 32 of the bottom surface 20 are positioned at an angle to one another in the range of 100 to 140 degrees. Essentially any angular orientation could be selected as desired, though the exemplary embodiment shows an obtuse angle.

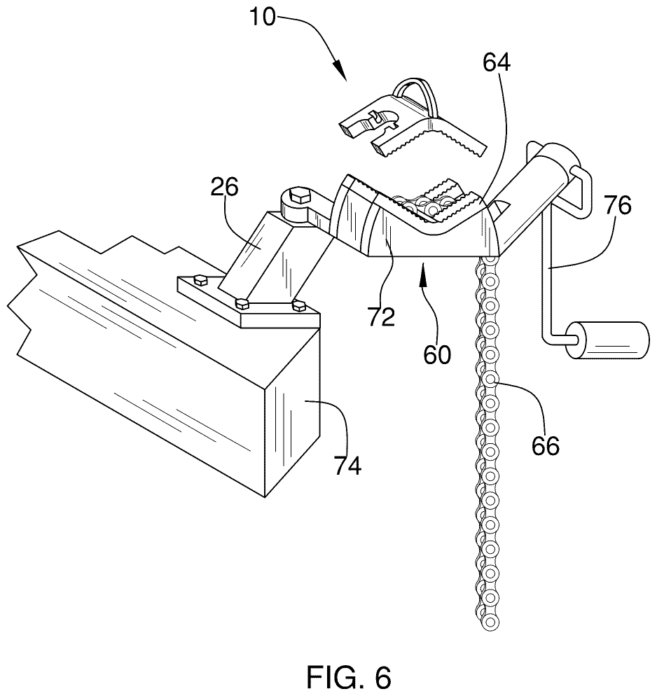

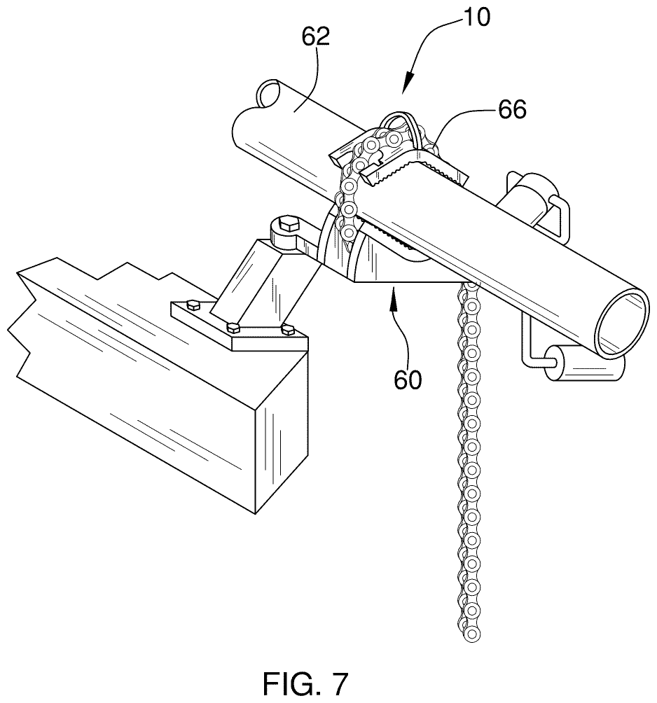

FIGS. 6 through 8 show the chain vise 60 for holding pipes that includes a base 72, which is mounted on a support structure 74, such as a table or bar. The jaw 64 is attached to an upper portion of the base 72. The jaw 64 includes teeth 14 designed to engage a portion of the pipe 62 placed on the jaw 64. The chain 66 is designed to be wrapped around the base 72 and the portion of the pipe 62 on the jaw 64 to hold the pipe 62 against the jaw 64. A crank handle 76 is used to tighten the chain 66 when locked in position. These components are fairly standard for chain vises. As shown in FIG. 7, instead of placing the chain 66 directly on the pipe 62 as is normally done, the holding device 10 is placed between the chain 66 and the pipe 62. As seen in FIG. 8, the link pins 68 are situated in the pin grooves 38 to further secure the chain 66, and the arch 36 guides the chain 66. The pipe 62 is therefore held more securely against slippage or rotation while being worked on, such as being cut in sections or having screw threads cut into the pipe 62. The holding device 10 can form part of the overall chain vise 60, though the holding device 10 is separate from the other components of the chain vise 60 to permit adjustability in placement on the pipe 62 and spacing from the jaw 64 of the chain vise 60 to accommodate pipes of different diameters.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A holding device for holding pipes in a chain vise comprising:
an angled bracket having a top surface, a bottom surface, and lateral surfaces connecting said top surface and said bottom surface, said angled bracket including a first bracket portion, a second bracket portion, and a central bracket portion connecting said first bracket portion and said second bracket portion, a first section of said bottom surface disposed on said first bracket portion and a second section of said bottom surface disposed on said second bracket portion forming an angle less than 160 degrees;
a plurality of teeth being disposed on said bottom surface, said teeth being configured to engage and grip an upper portion of a pipe positioned on a jaw of a chain vise; and
a pair of chain guide slots, each of said chain guide slots being disposed in a respective one of said first bracket portion and said second bracket portion, each of said chain guide slots being disposed to divide a respective one of said first bracket portion and said second bracket portion into a pair of legs extending away from said central bracket portion, each of said chain guide slots being configured to receive and guide between said pair of legs portions of a chain of the chain vise placed on said top surface of said angled bracket.

2. The holding device of claim 1, further comprising an arch projecting from said top surface of said angled bracket, said arch extending across said central bracket portion toward each of said lateral surfaces, said arch being configured to receive the chain of the chain vise inserted between said arch and said top surface of said angled bracket.

3. The holding device of claim 1, wherein:
the holding device further comprises a pair of pin grooves;
each of said pin grooves is disposed on opposing sides of said chain guide slot in said first bracket portion and extend toward a respective one of said lateral surfaces; and
said pin grooves are configured to receive any one of a plurality of link pins in the chain of the chain vise to further secure the chain of the chain vise in engagement with said angled bracket.

4. The holding device of claim 1, wherein:
each of said chain guide slots includes a wider slot portion and a narrower slot portion;
said wider slot portion extends from end faces of said pair of legs of a respective one of said first bracket portion and said second bracket portion toward said central bracket portion; and
said narrower slot portion extends from said wider slot portion toward said central bracket portion.

5. The holding device of claim 4, wherein:
each of said chain guide slots includes a wider slot portion and a narrower slot portion;
said wider slot portion extends from end faces of said pair of legs of a respective one of said first bracket portion and said second bracket portion toward said central bracket portion; and
said narrower slot portion extends from said wider slot portion toward said central bracket portion.

6. The holding device of claim 5, wherein said pin grooves are disposed to extend from said narrower slot portion of said chain guide slot of said first bracket portion.

7. The holding device of claim 6, wherein a width of said wider slot portion is the same as a distance between respective ends of said pin grooves to permit insertion of a link of the chain of the chain vise and the link pins projecting from the link into said wider slot portion between said pair of legs.

8. The holding device of claim 1, wherein said lateral surfaces are parallel to one another.

9. The holding device of claim 1, wherein said first section and said second section of said bottom surface are disposed at an angle to one another of less than 140 degrees.

10. The holding device of claim 1, wherein said first section and said second section of said bottom surface are disposed at an angle to one another in the range of 100 to 140 degrees.

11. The holding device of claim 1, wherein said bottom surface of said angled bracket is smooth and curved at said central bracket portion, and said teeth are disposed across the entirety of said bottom surface at each of said first bracket portion and said second bracket portion.

12. The holding device of claim 7, further comprising an arch projecting from said top surface of said angled bracket, said arch extending across said central bracket portion toward each of said lateral surfaces, said arch being configured to receive the chain of the chain vise inserted between said arch and said top surface of said angled bracket.

13. The holding device of claim 12, wherein said lateral surfaces are parallel to one another.

14. The holding device of claim 13, wherein said first section and said second section of said bottom surface are disposed at an angle to one another in the range of 100 to 140 degrees.

15. The holding device of claim 14, wherein said bottom surface of said angled bracket is smooth and curved at said central bracket portion, and said teeth are disposed across the entirety of said bottom surface at each of said first bracket portion and said second bracket portion.

15. A chain vise for holding pipes comprising:
a base;
a jaw attached to an upper portion of said base, said jaw including teeth configured to engage a portion of a pipe placed on said jaw;
a chain configured to be wrapped around said base and the portion of the pipe on said jaw to hold the pipe against said jaw; and
a holding device including:
an angled bracket having a top surface, a bottom surface, and lateral surfaces connecting said top surface and said bottom surface, said angled bracket including a first bracket portion, a second bracket portion, and a central bracket portion connecting said first bracket portion and said second bracket portion, a first section of said bottom surface disposed on said first bracket portion and a second section of said bottom surface disposed on said second bracket portion forming an angle less than 160 degrees;
a plurality of teeth being disposed on said bottom surface, said teeth being configured to engage and grip an upper portion of the pipe positioned on said jaw; and
a pair of chain guide slots, each of said chain guide slots being disposed in a respective one of said first bracket portion and said second bracket portion, each of said chain guide slots being disposed to divide a respective one of said first bracket portion and said second bracket portion into a pair of legs extending away from said central bracket portion, each of said chain guide slots being configured to receive and guide portions of said chain between said pair of legs.

15. The chain vise of claim 14, wherein:
said chain includes a plurality of link pins projecting out of respective links of said chain;
said holding device further comprises a pair of pin grooves;
each of said pin grooves is disposed on opposing sides of said chain guide slot in said first bracket portion and extend toward a respective one of said lateral surfaces; and
said pin grooves are configured to receive any one of said link pins to further secure said chain in engagement with said angled bracket.

16. The chain vise of claim 15, wherein:
each of said chain guide slots includes a wider slot portion and a narrower slot portion;
said wider slot portion extends from end faces of said pair of legs of a respective one of said first bracket portion and said second bracket portion toward said central bracket portion; and
said narrower slot portion extends from said wider slot portion toward said central bracket portion.

17. The chain vise of claim 16, wherein said pin grooves are disposed to extend from said narrower slot portion of said chain guide slot of said first bracket portion.

18. The chain vise of claim 17, wherein a width of said wider slot portion is the same as a distance between respective ends of said pin grooves to permit insertion of one of said links of said chain and its respective link pin into said wider slot portion between said pair of legs.

19. The holding device of claim 18, further comprising an arch projecting from said top surface of said angled bracket, said arch extending across said central bracket portion toward each of said lateral surfaces, said arch being configured to receive said chain of said chain vise inserted between said arch and said top surface of said angled bracket.

20. The chain vise of claim 19, wherein:
said lateral surfaces are parallel to one another;
said bottom surface of said angled bracket is smooth and curved at said central bracket portion;
said teeth are disposed across the entirety of said bottom surface at each of said first bracket portion and said second bracket portion; and
said first section and said second section of said bottom surface are disposed at an angle to one another in the range of 100 to 140 degrees.
